(19) United States
(12) Patent Application Publication
(10) Pub. No.: US 2010/0215512 A1
(43) Pub. Date: Aug. 26, 2010

(54) METHOD FOR OPERATING A COMPRESSOR ARRANGEMENT, AND A COMPRESSOR ARRANGEMENT

(76) Inventor: Ulrich Schwulera, Ratingen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/522,291

(22) PCT Filed: Dec. 19, 2007
(86) PCT No.: PCT/EP07/64236

§ 371 Date: Jul. 7, 2009

(30) Foreign Application Priority Data
Jan. 8, 2007 (EP) 07000271.2

(51) Int. Cl. F04B 49/06; F02C 6/04; F04B 35/04

(52) U.S. Cl. 417/53; 60/784; 417/410.1

(57) ABSTRACT

A method is provided for operating a compressor arrangement, particularly a pipeline compressor station, wherein the compressor arrangement has a turbine and a compressor in a torque-transferring connection. Previous systems work over long periods with poor efficiency when the turbine is working under a partial load. A solution is provided which includes an electrodynamic machine having a torque-transferring connection to the compressor, wherein the turbine has a maximum efficiency at a specific output, and when the compressor output is below the specific output, the electrodynamic machine is operated as a generator, and when the compressor output is above the specific output, the electrodynamic machine is operated as a motor.

### CROSS REFERENCE TO RELATED APPLICATIONS

This application is the US National Stage of International Application No. PCT/EP2007/064236, filed Dec. 19, 2007 and claims the benefit thereof. The International Application claims the benefits of European Patent Office application No. 07000271.2 EP filed Jan. 8, 2007, both of the applications are incorporated by reference herein in their entirety.

### FIELD OF INVENTION

The invention refers to a method for operating a compressor arrangement, especially a pipeline compressor station, which compressor arrangement has a turbine and a compressor which are in torque-transmitting communication, wherein an electrodynamic machine is in torque-transmitting communication with the compressor, wherein the turbine with a specified first turbine output has an efficiency maximum, wherein in the case of a compressor output below the first turbine output the electrodynamic machine is operated as a generator, and in the case of a compressor output above the first turbine output the electrodynamic machine is operated as a motor. In addition, the invention refers to a compressor arrangement for the operation according to the method according to the invention.

### BACKGROUND OF INVENTION

In the course of increasing raw material shortage and in the shadow of the threatening climate change it becomes the priority task of energy-converting machines to care for the scarce resources and to limit the emissions, especially the emission of climate-affecting gases. Therefore, standing by not only ethical appeals, so-called CO₂ certificates were introduced in Europe in reaction to resolutions of the Kyoto protocol, which increases the economical interests for a reduction of the emission of so-called greenhouse-gases. This motivation increasingly also embraces smaller and more special units.

A task which is related to the previously described problems is the distribution of natural gas by means of a network of pipelines which in its mesh-connected state is particularly difficult to operate in the case of simultaneously irregular distribution of the consumers. At various positions of the mesh-connected network, sets of agreements specify in which pressure range which amount of gas in standard cubic meters has to be made available over a certain period of time. The gas requirement at the consumer stations in this case is fluctuating, however, in such a way that the requirement frequently borders upon the technical limits and, calling upon all capacities, has to be unconditionally prevented, in such a way that pressures fall below contractually permissible limits. This happens at times, however, despite determined use of so-called pipeline compressor stations and costly trials by means of mathematical simulations to allow the gas network to optimally “breathe” at the right moment. In this case, it frequently happens that the pipeline compressor stations over a certain period of time create a pressure difference when delivering the gas in one direction, and during a subsequent interval of time deliver the gas in the opposite direction. Within the scope of technical feasibility, a pipeline compressor station in this case delivers fluctuating volumetric flows of 0-1.000.000 standard cubic meters per hour in both directions, wherein the drive of the compressor arrangement has to endure a fluctuation of the driving power of at least 65%-105%. The compressors of the compressor arrangements are regularly driven by means of gas turbines which achieve their optimum efficiency under full load, that is to say at 100% nominal output, and in the partial load range or in the case of overload regularly feature dramatic efficiency losses. Furthermore, the partial load range is also accompanied by additionally undesirable emissions and a disproportionally high curtailment of the service life.

Arrangements and principles of operation of the type referred to in the introduction are already known from WO 2005/047789A2 and U.S. Pat. No. 5,689,141.

### SUMMARY OF INVENTION

Starting from the previously described difficulties, the invention has made it its task to create methods for operating compressor stations, and to create a compressor station which even in the case of fluctuating load has both good efficiency and good emission values in all load ranges.

For solving the problem, according to the invention a method which is referred to in the introduction with the features of the claims are proposed, and a compressor plant with the features of the claims are proposed.

As a result of the variable use according to the invention of the electrodynamic machine, the turbine, which is preferably designed as a gas turbine, succeeds in constantly operating closer to the efficiency maximum in the partial load range or within the range of an overload than is the case with conventional plants. The entire plant is preferably constantly operated very close to the efficiency maximum of the turbine or gas turbine so that both the fuel consumption and the pollutant emission are minimal.

Should the maximum of the thermal efficiency and the minimum of the emission not lie at the same operating point of the turbine or gas turbine, in this case a for example economically oriented compromise can determine the preferred operating point.

The electrodynamic machine, during operation as a motor, is supplied from an electricity supply system, to which the power which is generated during operation as a generator is re-supplied, preferably via the interposition of a frequency converter. In this way, on the one hand the operator saves on fuel for the operation, and on the other hand saves on expenditure for emissions licenses. Furthermore, possibly when utilizing the non-optimum operating ranges of the turbine, this arrangement can cope with higher peak loads on account of the switching-in capability of the electrodynamic machine as a motor. A gas turbine, which for example can be operated between 4 and 8 MW, in combination with an electrodynamic machine according to the invention which has 4 MW output, can operate a compressor with an output of between 0 and 12 MW of driving power. If in this case the turbine is operated only with an optimum efficiency of for example 7 MW, the latitude is still between 3 MW and 11 MW of driving power.

In the case of a reversible delivery direction of the compressor arrangement, even in the case of high fluctuations with regard to the delivery pressure and the volumetric flow, exceedingly high efficiencies are achieved with the plant according to the invention.

The concept according to the invention is suitable both for compressor arrangements which are operated at constant speed and for example with an inlet guide vane assembly of the compressor, and for compressor arrangements with variable speed, wherein when connecting the electrodynamic machine to the electric power supply network a frequency converter is regularly to be provided.

The turbine, especially in the case of a gas turbine, can advantageously also be brought up to a corresponding speed by means of the electrodynamic machine for starting, which makes a separate starter motor for the turbine superfluous.

So undesirable delays do not occur within the scope of maintenance operations on the compressor, this is preferably designed in a barrel-type construction and is not provided with a continuous shaft so that the electrodynamic machine can be attached only on one side of the compressor. The electrodynamic machine in this case is preferably equipped with a continuous shaft so that either the turbine is connected directly to the free end, or a torque-transmitting operational arrangement is preferably coupled to a free end of the independent turbine shaft. This second shaft arrangement has particular advantages with regard to the use of standard modules and brings along an expedient shaft dynamic.

In conjunction with the electrodynamic machine according to the invention, the rotor dynamic is of particular importance because a combined shaft train consisting of turbine, electrodynamic machine and compressor would have a particularly complex rotor dynamic, especially with regard to bending fatigue, on account of the length of the arrangement.

### BRIEF DESCRIPTION OF THE DRAWINGS

In the following text, a special exemplary embodiment is described with reference to drawings for clarification. This description has only exemplary qualities because within the spirit of the invention further embodiment possibilities also arise for the person skilled in the art in addition to those described in detail here. In the drawing:

FIG. 1 shows a schematic view of a gas distribution network,

FIG. 2 shows a schematic view of a compressor arrangement according to the invention which is operated by means of the method according to the invention.

### DETAILED DESCRIPTION OF INVENTION

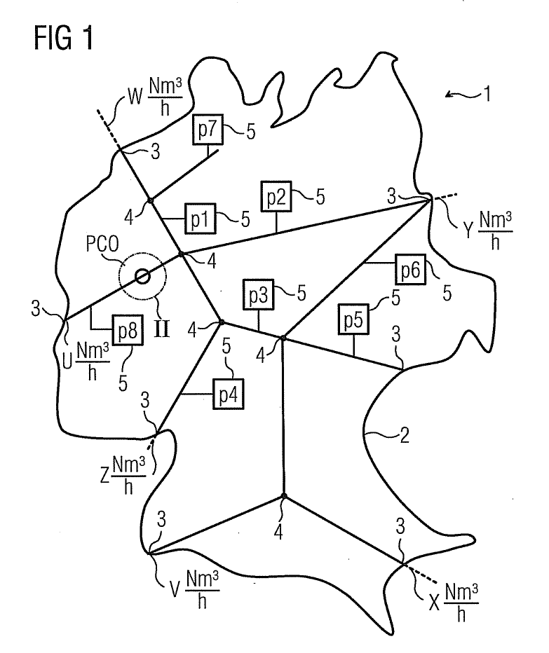

FIG. 1 shows a gas distribution network 1 which extends over a specified territory 2 and has various interfaces 3 to adjacent regions. At the interfaces, standard volumetric flows U, V, W, X, Y, Z flow into or out of the gas distribution network 1 of the territory 2 at specified pressure levels in each case. The pressure level can lie for example between 50 and 100 bar. In the case of the gas distribution network 1 it is a mesh-connected network with a plurality of junction points 4. Supplier tappings 5, at which gas of a specified individual pressure p1-p10 is tapped from the gas distribution network 1, are located at various sites. At the same time it is possible that storage feeds into the network take place. The pressure p1-p10 can fluctuate within contractually stipulated limits which in most cases are stipulated between 50 and 100 bar. At various points in the gas distribution network 1 a pipeline compressor station PCO or compressor arrangement COAN is arranged in each case, wherein only a single one is exemplarily drawn in FIG. 1. The task of the pipeline compressor station PCO, which corresponds to the compressor arrangement COAN according to the invention, is to ensure the various standard volumetric flows and pressures at the supplier tappings 5. The tappings in this case, especially when seasonally correlated, can fluctuate greatly, just as the standard volumetric flows U, V, W, X, Y, Z at the interfaces 3 of the gas distribution network 1 so that only operating situations which are difficult to predict result for the pipeline compressor station PCO. Both the pressures p1-p10 and the standard volumetric flows U, V, W, X, Y, Z are subjected to correspondingly large fluctuations, for example fluctuations of between 0 and 1.000.000 cubic meters per hour even when reversing the delivery direction.

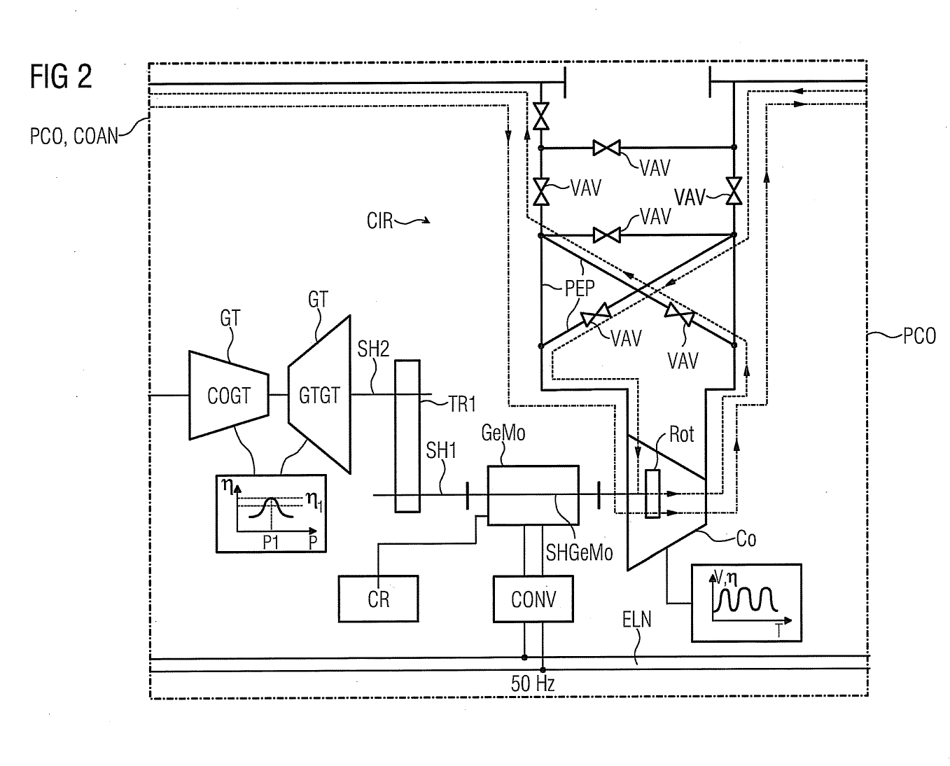

FIG. 2 shows a schematic view of the pipeline compressor station PCO or of a compressor arrangement COAN according to the invention from FIG. 1 in detail, which is operated by means of the method according to the invention. The compressor arrangement COAN according to the invention of the exemplary embodiment essentially comprises a gas turbine GT with a compressor COGT and a turbine GTGT, an electrodynamic machine GeMo according to the invention, and a compressor Co. The compressor Co is located with the electrodynamic machine GeMo on a first shaft train SH1. The turbine compressor COGT together with the turbine GTGT of the gas turbine is located on a second shaft train SH2 which is in a torque-transmitting communication, in the form of a transmission TR1, with the first shaft train SH1. The compressor Co is designed in a barrel-type of construction so that no provision is made for a continuous shaft as part of the first shaft train SH1 of the compressor Co. The side of the compressor casing CoCs from which no end of the shaft train SH1 emerges can be opened for maintenance operations so that for example a rotor wheel Rot, which is not shown in detail, can be exchanged with only little expenditure of time.

The electrodynamic machine GeMo, with a shaft SHGeMo which continues through a casing, is designed as a component part of the first shaft train SH1 so that the compressor Co is arranged on a first end of the shaft Si of the electrodynamic machine GeMo, and the transmission TR1 is arranged on a second end of the shaft. The electrodynamic machine GeMo is in electrically conducting communication with a frequency converter CONY so that electrical energy with the network frequency of 50 Hz, which is generated by the electrodynamic machine GeMo at different rotational frequencies, can be supplied to a connected electric network ELN. In addition, the frequency converter CONV serves for speed control of the compressor drive by means of the electrodynamic machine GeMo.

The compressor Co is connected to the gas distribution network 1 and enables the delivery of volumetric flows (standard volumetric flows U, V, W, X, Y, Z) according to requirement in one direction or in the opposite direction of a pipeline PL of the gas distribution network 1. This possibility is opened up by means of an arrangement CIR of gas lines PEP and valves VAV. Depending upon the opening of specific valves VAV, this arrangement CONY, which also comprises a piping arrangement which is generally referred to as a “braces connection”, enables a delivery of gas by means of the unmodified compressor Co in the one direction or in the opposite direction of the pipeline PL. These two different possibilities are shown in FIG. 2 with dash-dot lines or dashed lines.

The method according to the invention for operating the pipeline compressor station PCO or the compressor arrangement COAN makes provision for the gas turbine GT with a specified output P to have a maximum of the efficiency η, as is indicated by means of the sketched diagram in FIG. 2. The fluctuating load demands on the compressor Co, as is indicated in FIG. 2 by means of the diagram which shows the volumetric flow V over the time T, mean in the case of conventional plants that the gas turbine GT over long periods of time is to be operated within the ranges of only moderate efficiency η. According to the method according to the invention for operating the compressor arrangement COAN, the electrodynamic machine compensates the load peaks and valleys of the compressor Co so that the gas turbine is constantly operated closer within the range of the maximum efficiency GT, that is to say closer to the efficiency optimum. In this case, it is provided that the electrodynamic machine GeMo, in the case of a load demand from the compressor Co which is lower than the first output P1 at which the gas turbine has the efficiency maximum η1, is operated as a generator, and if the compressor Co has an output demand which is higher than the first output P1, the electrodynamic machine is operated as a motor. For this purpose, a control system CR is provided, which controls the electrodynamic machine according to the operating situation. The electric power which is generated during the generator operation of the electrodynamic machine GeMo is brought to the network frequency by means of the frequency converter CONY and supplied to the electric network ELN.

1.-6. (canceled)

7. A method for operating a compressor arrangement, comprising:
providing a turbine and a compressor in torque-transmitting communication, the turbine having an efficiency maximum corresponding to a specific first turbine output;
providing an electrodynamic machine in torque-transmitting communication with the compressor;
operating the electrodynamic machine as a generator when a compressor output is below the specific first turbine output; and
operating the electrodynamic machine as a motor when the compressor output is above the specific first turbine output,
wherein a delivery direction of the compressor arrangement is reversible.

8. The method as claimed in claim 7, wherein the compressor arrangement is a pipeline compressor station.

9. The method as claimed in claim 7, wherein the turbine in the compressor arrangement is a gas turbine.

10. The method as claimed in claim 7, wherein the compressor is operated essentially at a constant speed.

11. The method as claimed in claim 7, wherein the compressor is operated at a variable speed.

12. The method as claimed in claim 7,
wherein an electric power generated by the generator is supplied to an electric network, and
wherein a frequency converter is in an electrical communication with the electrodynamic machine and is used to supply an appropriate frequency to the electric network.

13. The method as claimed in claim 12, wherein when the electrodynamic machine is operating as the motor, electricity is supplied to the motor from the electric power generated when the electrodynamic machine operated as the generator.

14. A compressor arrangement connected to a gas distribution network, comprising:
a turbine;
a compressor;
a control system; and
an electrodynamic machine,
wherein the turbine and the compressor are in torque-transmitting communication with each other,
wherein the electrodynamic machine is in torque-transmitting communication with the compressor,
wherein the turbine has a specific first output corresponding to the turbine achieving an efficiency maximum,
wherein the control system controls a power input and a power output of the electrodynamic machine so that when a compressor output is below a specific first output of the turbine, the electrodynamic machine is operated as a generator, and when the compressor output is above the specific first output, the electrodynamic machine is operated as a motor, and
wherein the compressor enables a delivery of a plurality of volumetric flows in a direction or in an opposite direction of a pipeline of the gas distribution network.

15. The compressor arrangement as claimed in claim 14, wherein the turbine and the compressor each include an independent shaft which are separate from each other.

16. The compressor arrangement as claimed in claim 14,
wherein the compressor is designed in a barrel-type of construction, and
wherein the compressor does not include a continuous shaft.

17. The compressor arrangement as claimed in claim 14, wherein the electrodynamic machine includes the continuous shaft.

18. The compressor arrangement as claimed in claim 14, wherein the turbine in the compressor arrangement is a gas turbine.

19. The compressor arrangement as claimed in claim 14,
wherein an electric power generated by the generator is supplied to an electric network, and
wherein a frequency converter is in an electrical communication with the electrodynamic machine and is used to supply an appropriate frequency to the electric network.

20. The compressor arrangement as claimed in claim 19, wherein when the electrodynamic machine is operating as the motor, electricity is supplied to the motor from the electric power generated when the electrodynamic machine operated as the generator.

21. The compressor arrangement as claimed in claim 14, wherein a pressure of each of the plurality of volumetric flows flowing into or out of the gas distribution network lies in a range of between 50 and 100 bar.
